(19) United States
(12) Patent Application Publication
(10) Pub. No.: US 2026/0024799 A1
(43) Pub. Date: Jan. 22, 2026

(54) ELECTRODE TAB BENDING DEVICE AND ELECTRODE TAB BENDING METHOD

(71) Applicant: SAMSUNG SDI CO., LTD., Yongin-Si Gyeonggi-do (KR)

(72) Inventors: Yejin SEO, Yongin-Si (KR); Donghyun KIM, Yongin-Si (KR); Eunjeong MOON, Yongin-Si (KR)

(21) Appl. No.: 19/170,764

(22) Filed: Apr. 4, 2025

(30) Foreign Application Priority Data
Jul. 22, 2024 (KR) 10-2024-0096703

(51) Int. Cl. H01M 10/04; H01M 50/533; H01M 50/54

(52) U.S. Cl. CPC H01M 10/0404; H01M 50/533; H01M 50/54

(57) ABSTRACT

A device and a method for bending an electrode tab. The device includes a support configured to support an electrode assembly including at least one electrode tab, a guide above the electrode tab and configured to move in a reciprocating manner toward and away from the electrode tab, and a jig below the electrode tab and configured to move in a reciprocating manner toward and away from the electrode tab. Further, the jig is positioned at a distance from the guide in a direction in which the electrode tab protrudes, and the jig is configured to move toward the electrode tab to press and bend the electrode tab.

### CROSS-REFERENCE TO RELATED APPLICATION

The present application claims priority to and the benefit of Korean Patent Application No. 10-2024-0096703, filed on Jul. 22, 2024, in the Korean Intellectual Property Office, the entire disclosure of which is incorporated herein by reference.

### BACKGROUND

### 1. Field

Aspects of some embodiments of the present disclosure relate to an electrode tab bending device and an electrode tab bending method.

### 2. Description of the Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The electrode assembly may include a laminated electrode assembly having a structure in which long sheet-type positive and negative electrodes are wound with a separator interposed therebetween, and a stacked electrode assembly having a structure in which a plurality of positive and negative electrodes, cut into predetermined sizes, are sequentially stacked with a separator interposed therebetween.

The secondary battery may be classified into various types, such as cylindrical, prismatic, and pouch types, depending on its shape, and the electrode assembly may be applicable to various secondary batteries. In certain types of secondary batteries, thinning of the secondary battery may be required to increase energy density. In certain types of secondary batteries, the lengths of the electrode terminals and electrode tabs of the electrode assembly may pose challenges to the thinning of the secondary battery.

Accordingly, various efforts have been directed toward minimizing the bending length of the electrode tab of the electrode assembly.

The above information disclosed in this Background section is for enhancement of understanding of the background of the present disclosure, and therefore, it may contain information that does not constitute related (or prior) art.

### SUMMARY

To solve the problems described above, aspects of embodiments of the present disclosure relate to an electrode tab bending device and an electrode tab bending method capable of minimizing (or at least reducing) a bending length of an electrode tab of the electrode assembly.

These and other aspects and features of the present disclosure will be described in or will be apparent from the following description of embodiments of the present disclosure.

A device for bending an electrode tab according to one embodiment of the present disclosure includes a support configured to support an electrode assembly including at least one electrode tab, a guide above the electrode tab and configured to move in a reciprocating manner toward and away from the electrode tab, and a jig below the electrode tab and configured to move in a reciprocating manner toward and away from the electrode tab. Further, the jig is positioned at a distance from the guide in a direction in which the electrode tab protrudes, and the jig is configured to move toward the electrode tab to press and bend the electrode tab.

According to one embodiment, the guide may be configured to move downward toward the electrode tab to press the electrode tab, and the jig may be configured to move upward toward the electrode tab to press the electrode tab.

According to one embodiment, the guide may be configured to move downward toward the electrode tab to press the electrode tab, the electrode tab may be connected to a strip terminal, and the jig may press the strip terminal.

According to one embodiment, the guide may be configured to press the electrode tab at a position spaced apart from the strip terminal.

According to one embodiment, the jig may be configured to move such that an upper end of the jig is above a lower end of the guide, thereby bending the electrode tab.

According to one embodiment, the guide may be configured to move until the lower end of the guide reaches a height such that the lower end of the guide is substantially co-planar with a lower end of the electrode assembly, and the jig may be configured to move until the upper end of the jig reaches a height such that the upper end of the jib is substantially co-planar with an upper end of the electrode assembly, thereby bending the electrode tab.

According to one embodiment, the jig may be configured to move horizontally in a reciprocating manner toward and away from the electrode assembly.

According to one embodiment, the device described above may further include a roller on the electrode assembly and configured to move substantially horizontally in a reciprocating manner toward and away from the electrode assembly.

According to one embodiment, the roller may be configured to move along in a direction substantially parallel to a shared plane formed by an upper end of the electrode assembly and an upper end of the jig, thereby bending the strip terminal.

According to one embodiment, the guide may include a lower surface facing the electrode tab, a first side surface extending upward from the lower surface, and a second side surface extending upward from the lower surface. An edge formed by the first side surface and the lower surface may be curved, and an edge formed by the second side surface and the lower surface may be curved.

According to one embodiment, the jig may include an upper surface facing the strip terminal, a first side surface extending downward from the upper surface, and a second side surface extending downward from the upper surface. The second side surface may face a stack of the electrode assembly, and an edge formed by the upper surface and the second side surface may be curved.

According to one embodiment, the guide may be positioned at a distance in a range from approximately 0 mm to approximately 0.5 mm from the stack of the electrode assembly in the direction in which the electrode tab protrudes.

According to one embodiment, the jig may be positioned at a distance in a range from approximately 0.5 mm to approximately 1.3 mm from the guide in the direction in which the electrode tab protrudes.

A method for bending an electrode tab of an electrode assembly according to one embodiment of the present disclosure includes preparing an electrode assembly including at least one electrode tab connected to a strip terminal, placing the electrode assembly on a support, pressing the electrode tab using a guide that is controlled to move downward toward the electrode tab by a controller, pressing the electrode tab using a jig that is controlled to move upward toward the electrode tab by the controller, and bending the electrode tab by moving, by the controller, the jig such that an upper end of the jig is positioned above a lower end of the guide.

According to one embodiment, the pressing of the electrode tab using the guide may include pressing the electrode tab by the guide at a position spaced apart from the strip terminal.

According to one embodiment, the pressing of the electrode tab using the guide may include moving the guide until the lower end of the guide reaches a height such that lower end of the guide is substantially co-planar with a lower end of the electrode assembly.

According to one embodiment, the pressing of the electrode tab using the jig may include pressing the strip terminal by the jig.

According to one embodiment, the bending of the electrode tab may include moving the jig until the upper end of the jig reaches a height such that the upper end of the jig is substantially co-planar with an upper end of the electrode assembly.

According to one embodiment, the method described above may further include moving upward the guide by the controller; advancing, by the controller, the jig in a direction substantially opposite to a direction in which the electrode tab protrudes; and bending the strip terminal by moving, by the controller, the roller substantially horizontally in a reciprocating manner toward and away from the electrode assembly.

According to one embodiment, the bending of the strip terminal may include moving the roller along in a direction substantially parallel to a shared plane formed by an upper end of the electrode assembly and the upper end of the jig.

According to one embodiment of the present disclosure, the device and the method for bending the electrode tab that can minimize (or at least reduce) the bending length of the electrode tab of the electrode assembly are provided.

According to one embodiment of the present disclosure, the device and the method for bending the electrode tab that can readily bend the electrode tab of the electrode assembly are provided.

According to one embodiment of the present disclosure, by minimizing (or at least reducing) the bending length of the electrode tab of the electrode assembly, it is possible to provide a thin secondary battery.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates a side view of an electrode tab bending device according to one embodiment of the present disclosure.

FIG. 2 illustrates a side view of an electrode assembly according to one embodiment of the present disclosure.

FIG. 3 illustrates operations of a guide and a jig included in an electrode tab bending device according to one embodiment of the present disclosure.

FIG. 4 illustrates an electrode tab bent by a guide and a jig according to one embodiment of the present disclosure.

FIG. 5 illustrates an operation of a guide included in an electrode tab bending device according to one embodiment of the present disclosure.

FIG. 6 illustrates an operation of a jig included in an electrode tab bending device according to one embodiment of the present disclosure.

FIG. 7 illustrates operations of a jig and a roller included in an electrode tab bending device according to one embodiment of the present disclosure.

FIG. 8 illustrates a strip terminal bent by a jig and a roller according to one embodiment of the present disclosure.

FIG. 9 is a flowchart illustrating tasks of a method for bending an electrode tab using a guide and a jig according to one embodiment of the present disclosure.

FIG. 10 is a flowchart illustrating tasks of a method for bending a strip terminal using a jig and a roller according to one embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, the sizes and relative sizes of layers and regions shown in the drawings may be exaggerated for clarity of description. That is, the sizes shown in the drawings are only for convenience of understanding and are not limited thereto. Throughout the specification, like reference numerals will be given to like parts.

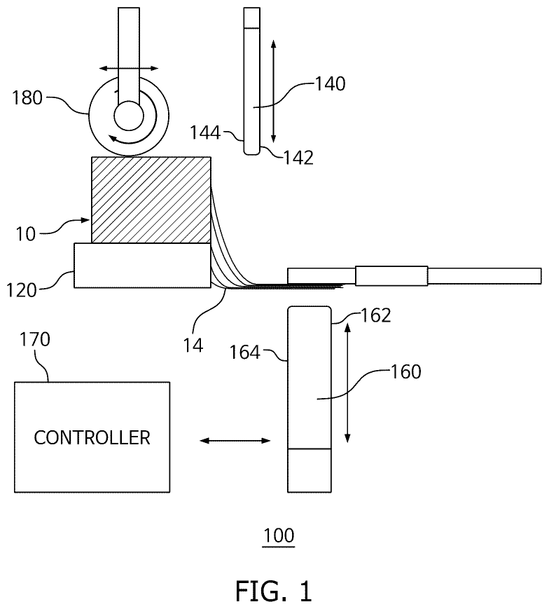

FIG. 1 illustrates a side view of an electrode tab bending device 100 according to one embodiment of the present disclosure.

In one embodiment, an electrode tab bending device 100 may include a support 120, a guide 140, and a jig 160. Further, the electrode tab bending device 100 may include a controller 170 configured to control the guide 140, the jig 160, and a roller 180.

The support 120 may support an electrode assembly 10, which includes one or more electrode tabs 14. The support 120 may secure a stack 12 of the electrode assembly 10. The electrode tab(s) 14 protruding from the stack 12 of the electrode assembly 10 may be bent using the guide 140 and the jig 160.

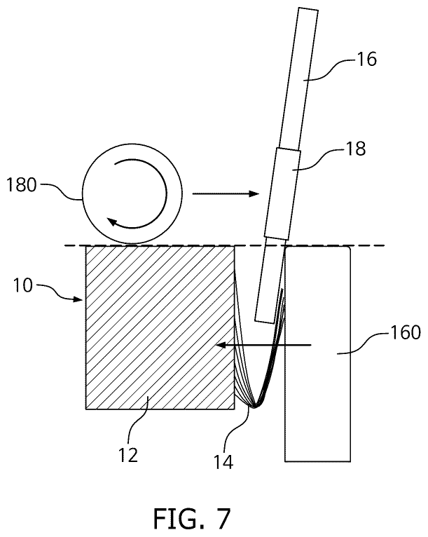

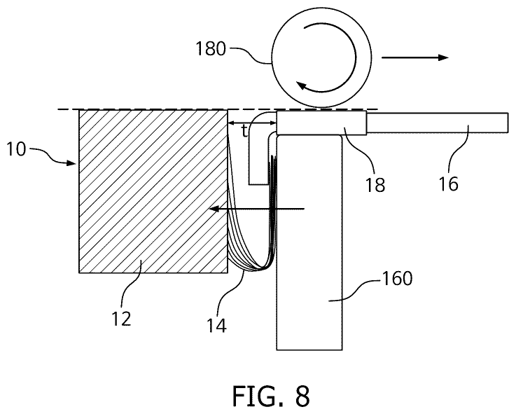

The electrode tab(s) 14 of the electrode assembly 10 may be connected to a strip terminal 16. The support 120 may secure the stack 12 of the electrode assembly 10. Accordingly, the strip terminal 16 protruding from the stack 12 of the electrode assembly 10 may be bent using the jig 160 and the roller 180. This configuration will be described in more detail later with reference to FIGS. 7 and 8.

The electrode assembly 10 may include the stack 12 having a first electrode plate, a separator, and a second electrode plate, which are each formed as thin plates or films. The stack 12 may be formed by winding or stacking the electrode plates and the separator.

When the electrode assembly 10 is a wound stack, a winding axis may be parallel to the longitudinal direction (e.g., the y direction) of the case. In other embodiments, the electrode assembly 10 may be a stack type rather than a winding type, and the shape of the electrode assembly is not limited in the present disclosure. In addition, the electrode assembly 10 may be a Z-stack electrode assembly in which a positive electrode plate and a negative electrode plate are inserted into both sides of a separator, which is then bent into a Z-stack. The first electrode plate of the electrode assembly 10 may act as a negative electrode, and the second electrode plate may act as a positive electrode. Of course, the reverse is also possible.

The first electrode plate may be formed by applying a first electrode active material, such as graphite or carbon, to a first electrode current collector formed of a metal foil, such as copper, a copper alloy, nickel, or a nickel alloy. The first electrode plate may include a first electrode tab (e.g., a first uncoated portion) that is a region to which the first electrode active material is not applied. The first electrode tab may act as a current flow path between the first electrode plate and the first current collector. In some embodiments, when the first electrode plate is manufactured, the first electrode tab may be formed by being cut in advance to protrude to one side of the electrode assembly, or the first electrode tab may protrude to one side of the electrode assembly more than (e.g., farther than or beyond) the separator without being separately cut.

The second electrode plate may be formed by applying a second electrode active material, such as a transition metal oxide, on a second electrode current collector formed of a metal foil, such as aluminum or an aluminum alloy. The second electrode plate may include a second electrode tab (e.g., a second uncoated portion) that is a region to which the second electrode active material is not applied. The second electrode tab may act as a current flow path between the second electrode plate and the second current collector. In some embodiments, the second electrode tab may be formed by being cut in advance to protrude to the other side (e.g., the opposite side) of the electrode assembly when the second electrode plate is manufactured, or the second electrode plate may protrude to the other side of the electrode assembly more than (e.g., farther than or beyond) the separator without being separately cut.

In some embodiments, the first electrode tab may be located on the left side of the electrode assembly, and the second electrode tab may be located on the right side of the electrode assembly. In other embodiments, the first electrode tab and the second electrode tab may be located on one side of the electrode assembly in the same direction. Here, for convenience of description, the left and right sides are defined according to the secondary battery as oriented in FIG. 1, and the positions thereof may change when the secondary battery is rotated left and right or up and down.

The guide 140 may be positioned above the one or more electrode tabs 14 that protrude from the stack 12 of the electrode assembly 10. In one embodiment in which the electrode tab(s) 14 is at a lower end of the stack 12, the guide 140 may be positioned above the electrode tab(s) 14. The position of the guide 140 may vary depending on the alignment position of the electrode tab(s) 14 of the electrode assembly 10. The terms ‘upper’ or ‘lower’ as used in the present disclosure are intended to specify relative positions distinguished based on the electrode tab and may refer to one side or the other side, without being limited to a specific direction.

The guide 140 may be configured to move in a reciprocating manner toward and away from the electrode tab(s) 14 protruding from the stack 12 of the electrode assembly 10. In one embodiment, the guide 140 may be configured to move downward in a direction approaching the electrode tab(s) 14 and move upward in a direction away from the electrode tab(s) 14.

The guide 140 may be positioned at a distance of approximately 0 mm to approximately 0.5 mm from the stack 12 of the electrode assembly 10 in the direction in which the electrode tab(s) 14 protrude(s). In one or more embodiments, the guide 140 may include a material having a hardness of approximately HrC 45 or higher, and may have a thickness of approximately 0.5 mm or greater.

The guide 140 may be positioned at a distance in a height direction of approximately 0 mm from the stack 12 of the electrode assembly 10, and the thickness of the guide 140 may be approximately 0.5 mm. In this embodiment, the guide 140 may bend the electrode tab 14 to the maximum extent, thereby minimizing a bending length t (see FIG. 8) of the electrode tab(s) 14 protruding from the stack 12 of the electrode assembly 10. The bending length of the electrode tab(s) 14 refers to a length from the stack 12 of the electrode assembly 10 to one of the opposite ends of an insulating film 18 that is closest to the stack 12.

The jig 160 may be positioned below the electrode tab(s) 14 protruding from the stack 12 of the electrode assembly 10. In one embodiment in which the electrode tab(s) 14 of the electrode assembly 10 is at the lower end of the stack 12, the jig 160 may be positioned below the electrode tab 14. The position of the jig 160 may vary depending on the alignment position of the electrode tab(s) 14 of the electrode assembly 10.

The jig 160 may be configured to move in a reciprocating manner toward and away from the electrode tab(s) 14 protruding from the stack 12 of the electrode assembly 10. In one embodiment, the jig 160 may be configured to move upward in a direction approaching the electrode tab(s) 14 and to move downward in a direction away from the electrode tab(s) 14. In some embodiments, the jig 160 may be configured to move horizontally to the left toward the stack 12 of the electrode assembly 10, and to move horizontally to the right in a direction away from the stack 12.

The jig 160 may be spaced apart from the guide 140 in the direction in which the electrode tab(s) 14 protrude(s) from the stack 12 of the electrode assembly 10 (e.g., the jig 160 may be spaced apart from the guide 140 in a horizontal direction). The jig 160 may be positioned at a distance of approximately 0.5 mm to approximately 1.3 mm from the guide 140 in the protruding direction of the electrode tab(s) 14 (e.g., the horizontal direction). The jig 160 may include a material having a hardness of approximately HrC 45 or higher, and may have a thickness of approximately 0.5 mm or greater.

The jig 160 may be positioned at a distance of approximately 0.5 mm from the guide 140 in the protruding direction of the electrode tab(s) 14, and the thickness of the jig 160 may be approximately 0.5 mm. In this case, the jig 160 may bend the electrode tab 14 to the maximum extent, thereby minimizing the bending length t of the electrode tab(s) 14 protruding from the stack 12 of the electrode assembly 10, while simultaneously preventing (or at least mitigating) the bending of the jig 160 during the process of bending the electrode tab(s) 14.

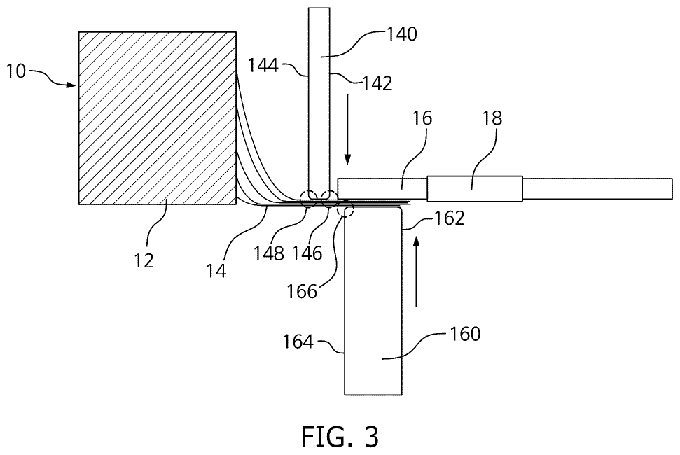

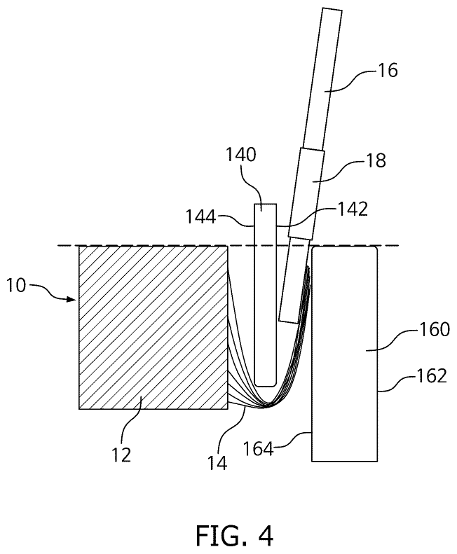

The jig 160 may be configured to move toward the electrode tab(s) 14 protruding from the stack 12 of the electrode assembly 10, thereby pressing a portion of a lower surface of the electrode tab(s) 14 to bend the electrode tab(s) 14. In one embodiment, the electrode tab(s) 14 of the electrode assembly 10 may be connected to the strip terminal 16, and the insulating film 18 may be formed on the strip terminal 16. The jig 160 may be configured to move toward the strip terminal 16, thereby pressing a portion of a lower surface of the insulating film 18 and/or the strip terminal 16 to bend the electrode tab(s) 14. This configuration will be described in more detail later with reference to FIGS. 3 and 4.

In one embodiment, the electrode tab bending device 100 may further include the roller 180. The roller 180 may be on the electrode assembly 10 and may be configured to move horizontally in a reciprocating manner toward and away from the electrode assembly 10. For example, in one or more embodiments, the roller 180 may be positioned on the electrode assembly 10 may be configured to move closer to or farther away from the electrode assembly 10 due to the horizontal reciprocating movement of the roller 180. The configuration of the roller 180 will be described in more detail later with reference to FIGS. 7 and 8.

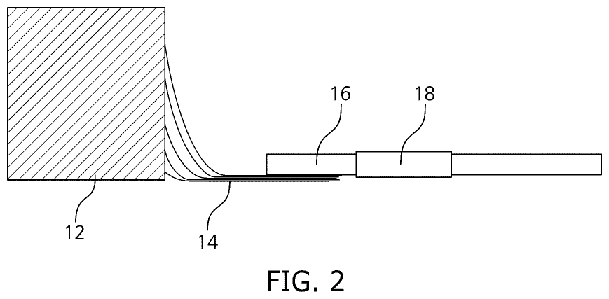

FIG. 2 illustrates a side view of an electrode assembly according to one embodiment of the present disclosure.

In one embodiment, the electrode assembly 10 may include the stack 12 and the electrode tab(s) 14 connected to the stack 12.

In one embodiment, the stack 12 may be formed by winding a positive electrode plate and a negative electrode plate with a separator interposed between the positive electrode plate and the negative electrode plate. However, the scope of the present disclosure is not limited thereto, and the stack 12 may have a structure in which a positive electrode plate and a negative electrode plate, each made of a plurality of sheets, are alternately stacked with a separator interposed therebetween.

In the stack 12, a positive electrode tab may be connected to one side of the positive electrode plate, and a negative electrode tab may be connected to one side of the negative electrode plate. The positive and negative electrode tabs may be connected to the positive and negative electrode plates, respectively, by welding the tabs to uncoated portions of the positive and negative electrode plates, or the positive and negative electrode tabs may be formed by punching out or cutting the positive and negative electrode plates. In the wound state, the positive and negative electrode tabs may be arranged side by side with a predetermined gap therebetween. Hereinafter, the term “electrode tab 14” is used to encompass either one or both of the positive electrode tab and the negative electrode tab.

The electrode tab(s) 14 may be connected so as to protrude outward from the stack 12. The electrode tab(s) 14 may be connected to the strip terminal 16 to allow the electrode assembly 10 to be electrically connected to an external device. A portion of the strip terminal 16 may be exposed to the outside of the case. The electrode tab(s) 14 and the strip terminal 16 may include or be formed of metal, such as aluminum, copper, or nickel, and may be formed of a metal having an electrical conductivity above a certain threshold to minimize (or at least reduce) a voltage drop.

The insulating film 18 may be formed on one or both of the upper and lower surfaces of the strip terminal 16. In some embodiments, the insulating film 18 may be attached to a portion of the strip terminal 16 that contacts a sealing area at an edge of the case.

The case may form an overall outer appearance of the secondary battery and may be made of a conductive metal such as aluminum, an aluminum alloy, or a nickel-plated steel. In some embodiments, the case may provide a space for accommodating the electrode assembly 10. In one embodiment, the case may be a pouch-type case, and the secondary battery may be a pouch-type secondary battery. However, the scope of the present disclosure is not limited thereto, and the secondary battery may be a battery cell of any shape, such as a circular shape, a prismatic shape, or a cylindrical shape.

The secondary battery may be a lithium battery cell, a sodium battery cell, or the like. However, the scope of the present disclosure is not limited thereto, and the secondary battery may be any battery capable of repeatedly providing electrical power through charging and discharging operations. In one embodiment in which the secondary battery is the lithium battery cell, the secondary battery may be used in an electric vehicle (EV) due to its lifespan and high-rate capability. For example, the lithium battery cell may be used in a hybrid vehicle such as a plug-in hybrid electric vehicle (PHEV). Further, the lithium battery cell may be used in applications where a large-scale power storage is required. For example, the lithium battery cell may be used in an electric bicycle, a power tool, or the like.

FIG. 3 illustrates operations of a guide 140 and a jig 160 included in an electrode tab bending device according to one embodiment of the present disclosure, and FIG. 4 illustrates an electrode tab 14 bent by a guide 140 and a jig 160 according to one embodiment of the present disclosure.

Referring to FIG. 3, the guide 140 may be configured to move downward toward the electrode tab(s) 14 protruding from the stack 12 of the electrode assembly 10 to press a portion of the upper surface of the electrode tab(s) 14.

The jig 160 may be configured to move upward toward the electrode tab(s) 14 protruding from the stack 12 of the electrode assembly 10 to press a portion of the lower surface of the electrode tab(s) 14. The guide 140 may be configured to first press the electrode tab(s) 14, and then the jig 160 may be configured to press the electrode tab(s) 14.

The electrode tab(s) 14 may be connected to the strip terminal 16. The insulating film 18 may be formed on at least a portion of the strip terminal 16. The jig 160 may be configured to press a portion of a lower surface of the insulating film 18 and/or the strip terminal 16. After initially pressing the lower surface of the electrode tab(s) 14, the jig 160 may, during its upward movement, come into contact with the strip terminal 16 and press the lower surface of the strip terminal 16 and/or the insulating film 18.

The guide 140 may include a lower surface facing the electrode tab(s) 14, a first side surface 142 extending upward from the lower surface, and a second side surface 144 extending upward from the lower surface. In one or more embodiments, the first side surface 142 and the second side surface 144 may be substantially parallel. The second side surface 144 of the guide 140 may be positioned toward the stack 12 of the electrode assembly 10 (e.g., the second side surface 144 may face the stack 12), and the first side surface 142 may be opposite to the second side surface 144. For example, the second side surface 144 of the guide 140 may be proximate (e.g., adjacent) to the stack 12 of the electrode assembly 10, and the first side surface 142 may be further away from the stack 12 of the electrode assembly 10 than the second side surface 144.

A first edge 146 formed by the first side surface 142 and the lower surface of the guide 140 may be curved (e.g., rounded or radiused). Further, a second edge 148 formed by the second side surface 144 and the lower surface of the guide 140 may be curved (e.g., rounded or radiused). In embodiments in which the first edge 146 and the second edge 148 of the guide 140 are curved, the radius of curvature (R) of each curved edge may be at least approximately 0.1 mm, which is configured to prevent (or at least mitigate) damage to the electrode tab(s) 14 while reducing the pressing area, thereby facilitating the bending of the electrode tab(s) 14.

The guide 140 may be configured to press the electrode tab 14 at a position spaced apart from the strip terminal 16. In one or more embodiments, the first edge 146, formed by the first side surface 142 and the lower surface of the guide 140, may be configured to press the electrode tab(s) 14 at a position spaced apart from the strip terminal 16. Further, the second edge 148, formed by the second side surface 144 and the lower surface of the guide 140, may be configured to press the electrode tab(s) 14 at a position spaced apart from the strip terminal 16.

The jig 160 may include an upper surface facing the strip terminal 16, a first side surface 162 extending downward from the upper surface, and a second side surface 164 extending downward from the upper surface. The first side surface 162 and the second side surface 164 may be substantially parallel. The second side surface 164 of the jig 160 may be positioned toward the stack 12 of the electrode assembly 10 (e.g., the second side surface 164 of the jig 160 may face the stack 12 of the electrode assembly 10), and an edge formed by the upper surface and the second side surface 164 may be curved (e.g., rounded or radiused). The first side surface 162 of the jig 160 may be opposite to the second side surface 164 (e.g., the first side surface 162 of the jig 160 may face away from the stack 12 of the electrode assembly 10). In an embodiment in which the edge formed by the upper surface and the second side surface 164 is curved, the radius of curvature (R) of the curved edge may be at least approximately 0.1 mm, which is configured to prevent (or at least mitigate) damage to the strip terminal 16 while reducing the pressing area, thereby facilitating the bending of the strip terminal 16.

The jig 160 may be configured to press the strip terminal 16. In one or more embodiments, the edge 166 formed by the second side surface 164 and the upper surface of the jig 160 may be configured to press the strip terminal 16 at an end of the insulating film 18. For example, the edge 166 of the jig 160 may be configured to press the strip terminal 16 at one of the opposite ends of the insulating film 18 that is proximate to the stack 12.

The jig 160 may be configured to move such that the upper end of the jig 160 is positioned above the lower end of the guide 140, thereby allowing the electrode tab(s) 14 to be bent. The relative movement positions of the guide 140 and the jig 160 for bending the electrode tab(s) 14 may be set differently depending on the alignment position of the electrode tab(s) 14 in the electrode assembly 10. The electrode tab(s) 14 may be bent at a position where the electrode tab(s) 14 is pressed by the edges 146 and 148 of the guide 140.

In one embodiment, the guide 140 may be configured to move (e.g., downward) until the lower end of the guide 140 reaches a height such the lower end of the guide 140 is substantially co-planar (flush or substantially flush) with the lower end of the stack 12 of the electrode assembly 10. The jig 160 may be configured move (e.g., upward) until the upper end of the jig 160 reaches a height such that the upper end of the jig 160 is substantially co-planar (flush or substantially flush) with the upper end of the stack 12 of the electrode assembly 10, thereby allowing the electrode tab(s) 14 to be bent. The movement of the guide 140 and the jig 160 may be performed simultaneously (or substantially simultaneously) or sequentially.

Each of the guide 140 and the jig 160 may be controlled to move to a height determined by the controller 170. As illustrated in FIG. 4, the electrode tab(s) 14 of the electrode assembly 10 may be bent by the guide 140 and the jig 160.

In one embodiment, the guide 140 may be positioned at a distance (e.g., in the height direction) of approximately 0 mm from the stack 12 of the electrode assembly 10, and the jig 160 may be positioned at a distance of approximately 0.5 mm from the guide 140 in the protruding direction of the electrode tab(s) 14. As a result, in an embodiment in which the thickness of the guide 140 is approximately 0.5 mm, the bending length of the electrode tab(s) 14 of the electrode assembly 10 may correspond to the sum of the thickness of the guide 140 and the spacing distance between the guide 140 and the jig 160. The bending length of the electrode tab(s) 14 of the electrode assembly 10 may vary depending on the thickness of the guide 140. The bending length of the electrode tab(s) 14 of the electrode assembly 10 may correspond to a distance from the stack 12 to the second side surface 164 of the jig 160.

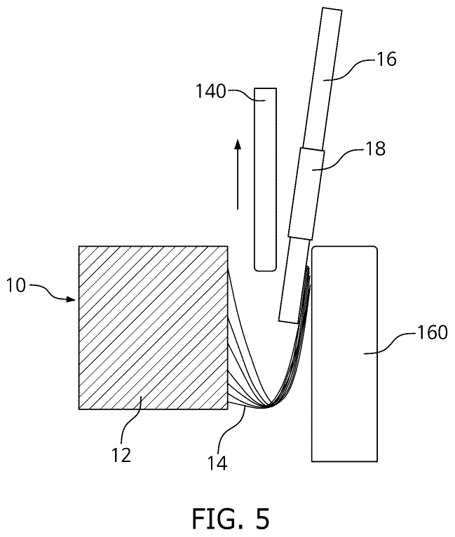

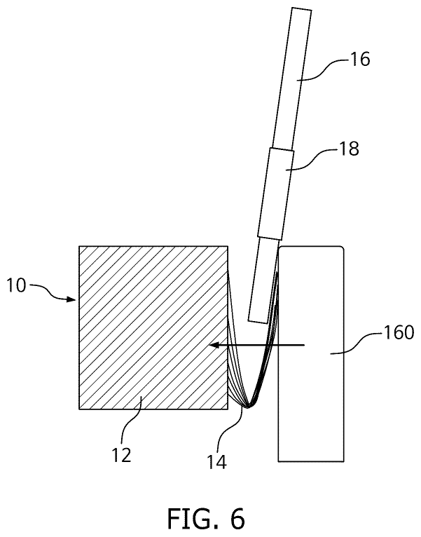

FIG. 5 illustrates an operation of a guide 140 included in an electrode tab bending device according to one embodiment of the present disclosure, and FIG. 6 illustrates an operation of a jig 160 included in an electrode tab bending device according to one embodiment of the present disclosure. The operations of the guide 140 and the jig 160 shown in FIGS. 5 and 6 may be performed consecutively after the operations shown in FIG. 4.

Referring to FIG. 5, the guide 140 may be configured to move upward in a direction away from the electrode tab(s) 14 to prepare for a subsequent process. Due to the upward movement of the guide 140, a space may be created for the jig 160 to advance toward the electrode assembly 10.

The jig 160 may be configured to move horizontally in a reciprocating manner toward and away from the electrode assembly 10. For example, the jig 160 may advance (move) toward the electrode assembly 10 and retreat (move) away from the electrode assembly 10.

Depending on the pressing position of the guide 140 and the jig 160, an additional bending of the electrode tab 14 may be performed. In one or more embodiments, an additional bending of the electrode tab 14 may be performed depending on the thickness of the guide 140. The jig 160 may be configured to advance toward the electrode assembly 10 to further bend the electrode tab 14.

FIG. 7 illustrates operations of a jig 160 and a roller 180 included in an electrode tab bending device according to one embodiment of the present disclosure, and FIG. 8 illustrates a strip terminal 16 bent by a jig 160 and a roller 180 according to one embodiment of the present disclosure. The operation of the roller 180 shown in FIGS. 7 and 8 may be performed consecutively following the operation shown in FIG. 6.

In one embodiment, the electrode tab bending device 100 may further include the roller 180 that may be configured to move horizontally in a reciprocating manner toward and away from the electrode assembly 10 while being positioned on the electrode assembly 10. For example, the roller 180 may be configured to move horizontally to approach the electrode assembly 10 or to move away from the electrode assembly 10. The roller 180 may be configured to move horizontally (or substantially horizontally) while in contact with an upper surface of the electrode assembly 10. Further, the roller 180 may be configured to move horizontally (or substantially horizontally) while in contact with an upper surface of the strip terminal 16. The roller 180 may be configured to move in a reciprocating manner (e.g., the horizontal movement) in a direction perpendicular (or substantially perpendicular) to the reciprocating movement direction (e.g., the vertical movement) of the guide 140 or the jig 160. The controller 170 of the electrode tab bending device 100 may control the movement of the roller 180.

The roller 180 may include an anodized aluminum material, and may have a size of approximately 4 mm in diameter, which is configured to prevent (or at least mitigate) dents on the surface of the electrode tab(s) 14, ensure good bending quality, and avoid (or at least mitigate) damage to the insulating film 18.

The roller 180 may move along in a direction parallel to a shared plane formed by the upper end of the stack 12 of the electrode assembly 10 and the upper end of the jig 160, allowing the strip terminal 16 to be bent. The position of the upper end of the jig 160 may be adjusted in consideration of the thickness of the strip terminal or the thickness of the insulating film. For example, the upper end of the jig 160 may be adjusted to move downward by an amount corresponding to the thickness of the strip terminal or the thickness of the insulating film. The shared plane formed by the upper end of the stack 12 of the electrode assembly 10 and the upper end of the jig 160 may be also used to include the plane that is formed as a result of the aforementioned adjustment of the position of the jig 160.

In one embodiment, the roller 180 may be configured to move along in a direction parallel (or substantially parallel) to the shared plane between the upper ends of the stack 12 and the jig 160 while the jig 160 advances toward the stack 12 of the electrode assembly 10. In one or more embodiments, the jig 160 may advance toward the stack 12 of the electrode assembly 10 after the roller 180 has moved along in a direction parallel (or substantially parallel) to the shared plane. In one or more embodiments, the jig 160 may advance toward the stack 12 of the electrode assembly 10 before the roller 180 moves in a direction parallel (or substantially parallel) to the shared plane. As a result, the roller 180 may readily bend the strip terminal 16 by allowing the jig 160 to press the strip terminal 16.

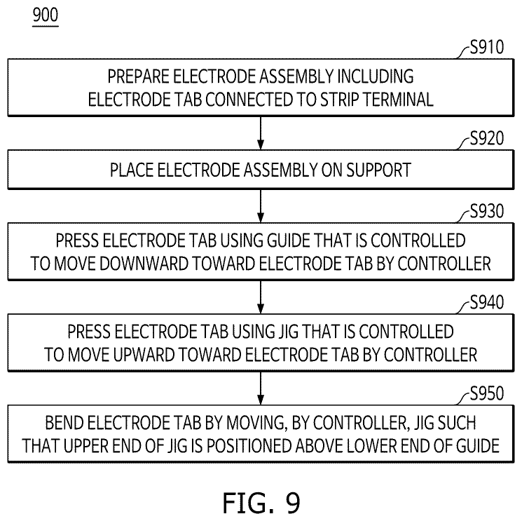

FIG. 9 is a flowchart illustrating tasks of a method 900 for bending an electrode tab(s) (i.e., an electrode tab bending method) using a guide and a jig according to one embodiment of the present disclosure. The electrode tab bending method 900 may be performed by the electrode tab bending device 100 described above.

The electrode tab bending method 900 may begin by preparing an electrode assembly that includes an electrode tab(s) connected to a strip terminal (step S910). Next, the electrode assembly may be placed on a support (step S920). The controller may then move the guide downward toward the electrode tab(s) so that the guide presses the electrode tab(s) (step S930). The controller may then move the jig upward toward the electrode tab so that the jig presses the electrode tab(s) (step S940). The controller may move the jig such that the upper end of the jig is positioned above the lower end of the guide, allowing the electrode tab(s) to be bent (step S950).

In one embodiment, the step S930 of pressing the electrode tab(s) with the guide may include pressing the electrode tab(s) 14 with the guide 140 at a position that is spaced apart from the strip terminal 16.

In one embodiment, the step S930 of pressing the electrode tab(s) with the guide may include moving the guide 140 until the lower end of the guide 140 reaches a height such that the lower end of the guide is substantially co-planar (flush or substantially flush) with the lower end of the electrode assembly or the stack.

In one embodiment, the step S940 of pressing the electrode tab(s) with the jig may include pressing the strip terminal 16 with the jig 160. The edge 166 formed by the second side surface 164 of the jig 160 and the upper surface of the jig may be positioned at an end that is proximate (close) to the stack 12 of the insulating film 18 included in the strip terminal 16, thereby pressing the strip terminal 16.

In one embodiment, the step S950 of bending the electrode tab(s) may include moving the jig 160 until the upper end of the jig reaches a height such that the upper end of the jig is substantially co-planar (flush or substantially flush) with the upper end of the electrode assembly 10 or the stack 12.

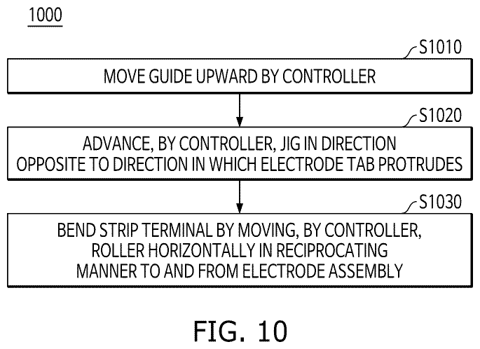

FIG. 10 is a flowchart illustrating tasks of a method for bending a strip terminal using a jig and a roller according to one embodiment of the present disclosure. A method 1000 of FIG. 10 may be performed by the electrode tab bending device 100 described above and may correspond to a subsequent process of the method shown in FIG. 9.

According to the electrode tab bending method 1000, the controller may move the guide upward (step S1010). Subsequently, the controller may advance the jig in a direction opposite to the protruding direction of the electrode tab(s) (step S1020). For example, the jig may move forward toward the electrode assembly. The controller may control the roller to move horizontally in a reciprocating manner toward and away from the electrode assembly, allowing the strip terminal to be bent (step S1030). In one embodiment, the step S1030 of bending the strip terminal may include controlling, by the controller, the roller 180 to move parallel (or substantially parallel) along the shared plane formed by the upper end of the stack 12 of the electrode assembly and the upper end of the jig 160.

The flowchart and the aforementioned descriptions illustrated in FIGS. 9 and 10 are merely examples of the present disclosure, and the scope of the present disclosure is not limited to the flowchart and the descriptions illustrated in FIGS. 9 and 10. For instance, one or more steps in the flowchart and the descriptions may be added, modified, or deleted; the sequence of one or more steps may be changed; and one or more steps may be performed simultaneously rather than sequentially.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### EXPLANATION OF REFERENCE SYMBOLS

10: electrode assembly
12: stack
14: electrode tab
16: strip terminal
100: electrode tab bending device
120: support 140: guide
146,148: edges of guide
160: jig
166: edge of jig
180: roller

What is claimed is:

1. A device comprising:
a support configured to support an electrode assembly comprising at least one electrode tab;
a guide above the at least one electrode tab, the guide being configured to move in a reciprocating manner toward and away from the at least one electrode tab; and
a jig below the at least one electrode tab, the jig being configured to move in a reciprocating manner toward and away from the at least one electrode tab,
wherein the jig is spaced apart from the guide by a distance in a direction in which the at least one electrode tab protrudes, and
wherein the jig is configured to move toward the at least one electrode tab to press and bend the at least one electrode tab.

2. The device as claimed in claim 1, wherein the guide is configured to move downward toward the at least one electrode tab to press the at least one electrode tab, and wherein the jig is configured to move upward toward the at least one electrode tab to press the at least one electrode tab.

3. The device as claimed in claim 1, wherein the guide is configured to move downward toward the at least one electrode tab to press the at least one electrode tab, wherein the at least one electrode tab is connected to a strip terminal, and wherein the jig is configured to press the strip terminal.

4. The device as claimed in claim 3, wherein the guide is configured to press the at least one electrode tab at a position spaced apart from the strip terminal.

5. The device as claimed in claim 4, wherein the jig is configured to move into a position such that an upper end of the jig is above a lower end of the guide, thereby bending the at least one electrode tab.

6. The device as claimed in claim 5, wherein the guide is configured to move until the lower end of the guide reaches a height substantially co-planar with a lower end of the electrode assembly, and
wherein the jig is configured to move until the upper end of the jig reaches a height substantially co-planar with an upper end of the electrode assembly, thereby bending the at least one electrode tab.

7. The device as claimed in claim 1, wherein the jig is configured to move horizontally in a reciprocating manner toward and away from the electrode assembly.

8. The device as claimed in claim 3, further comprising:
a roller on the electrode assembly, the roller being configured to move horizontally in a reciprocating manner toward and away from the electrode assembly.

9. The device as claimed in claim 8, wherein the roller is configured to move along in a direction substantially parallel to a shared plane formed by an upper end of the electrode assembly and an upper end of the jig when the jig is substantially co-planar with the upper end of the electrode assembly, thereby bending the strip terminal.

10. The device as claimed in claim 3, wherein the guide comprises a lower surface facing the electrode tab, a first side surface extending upward from the lower surface, and a second side surface extending upward from the lower surface,
wherein an edge formed by the first side surface and the lower surface is curved, and
wherein an edge formed by the second side surface and the lower surface is curved.

11. The device as claimed in claim 3, wherein the jig comprises an upper surface facing the strip terminal, a first side surface extending downward from the upper surface, and a second side surface extending downward from the upper surface,
wherein the second side surface faces the electrode assembly, and
wherein an edge formed by the upper surface and the second side surface is curved.

12. The device as claimed in claim 1, wherein the guide is positioned at a distance in a range from approximately 0 mm to approximately 0.5 mm from the electrode assembly in the direction in which the at least one electrode tab protrudes.

13. The device as claimed in claim 1, wherein the jig is positioned at a distance in a range from approximately 0.5 mm to approximately 1.3 mm from the guide in the direction in which the at least one electrode tab protrudes.

14. A method comprising:
preparing an electrode assembly comprising at least one electrode tab connected to a strip terminal;
placing the electrode assembly on a support;
pressing the at least one electrode tab using a guide that is controlled to move downward toward the at least one electrode tab by a controller;
pressing the at least one electrode tab using a jig that is controlled to move upward toward the at least one electrode tab by the controller; and
bending the electrode tab by moving, by the controller, the jig such that an upper end of the jig is above a lower end of the guide.

15. The method as claimed in claim 14, wherein the pressing of the at least one electrode tab using the guide comprises pressing the at least one electrode tab by the guide at a position spaced apart from the strip terminal.

16. The method as claimed in claim 14, wherein the pressing of the at least one electrode tab using the guide comprises moving the guide until a lower end of the guide reaches a height substantially co-planar with a lower end of the electrode assembly.

17. The method as claimed in claim 14, wherein the pressing of the at least one electrode tab using the jig comprises pressing the strip terminal by the jig.

18. The method as claimed in claim 14, wherein the bending of the at least one electrode tab comprises moving the jig until the upper end of the jig reaches a height substantially co-planar with an upper end of the electrode assembly.

19. The method as claimed in claim 14, further comprising:
moving the guide upward by the controller;
advancing, by the controller, the jig in a direction substantially opposite to a direction in which the at least one electrode tab protrudes; and
bending the strip terminal by moving, by the controller, a roller substantially horizontally in a reciprocating manner toward and away from the electrode assembly.

20. The method as claimed in claim 19, wherein the bending of the strip terminal comprises moving the roller in a direction substantially parallel to a shared plane formed by an upper end of the electrode assembly and the upper end of the jig when the upper end of the jig is substantially co-planar with the upper end of the electrode assembly.
